(19) United States
(12) Patent Application Publication
(10) Pub. No.: US 2018/0356028 A1
(43) Pub. Date: Dec. 13, 2018

(54) HANGER

(71) Applicant: WELLSCO INTERNATIONAL GROUP CO., LTD., HANGZHOU (CN)

(72) Inventor: SHIH-HAO FANG, TAIPEI CITY (TW)

(21) Appl. No.: 15/618,523

(22) Filed: Jun. 9, 2017

(51) Int. Cl. F16M 13/02

(52) U.S. Cl. CPC F16M 13/02

(57) ABSTRACT

A hanger has a body made of nylon, is U-shaped in cross section, and has two ends and two through holes. The two through holes are defined respectively through the two ends of the body.

### BACKGROUND OF THE INVENTION

### 1. Field of the Invention The present invention relates to a hanger, and more particularly to a hanger that can hold a fastener firmly.

### 2. Description of Related Art

A conventional hanger is attached to a flat object, such as a wall or a cabinet, and has a U-shaped body having two ends. Two through holes are defined respectively through the two ends of the body. To securely attach the hanger on the flat object, two fasteners, such as nails or screws, are mounted respectively through the two through holes in the body and are inserted into the flat object. Thus, the hanger is securely attached to the flat object for hanging objects.

In practice, the two fasteners are usually held in advance in the through holes in the body of the hanger, such that a user can securely attach the hanger onto the flat object conveniently. However, because the conventional hanger is made of a metal sheet with a pressing process, the fasteners cannot be held in the through holes firmly. Therefore, the fasteners easily escape from the through holes, and the hanger cannot be attached to the flat object without the fasteners. In addition, the conventional hanger made of a metal sheet does not have a sufficient structural strength, so the conventional hanger is easily deformed.

To overcome the shortcomings, the present invention tends to provide a hanger to mitigate or obviate the aforementioned problems.

### SUMMARY OF THE INVENTION

The main objective of the invention is to provide a hanger that can hold fasteners firmly to keep the fasteners from escaping from the hanger.

The hanger has a body made of nylon, is U-shaped in cross section, and has two ends and two through holes. The two through holes are defined respectively through the two ends of the body.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a hanger in accordance with the present invention;

FIG. 2 is a front view of the hanger in FIG. 1; and

FIG. 3 is a top view in partial section of the hanger along the line 3-3 in FIG. 2.

### DETAILED DESCRIPTION OF PREFERRED EMBODIMENT

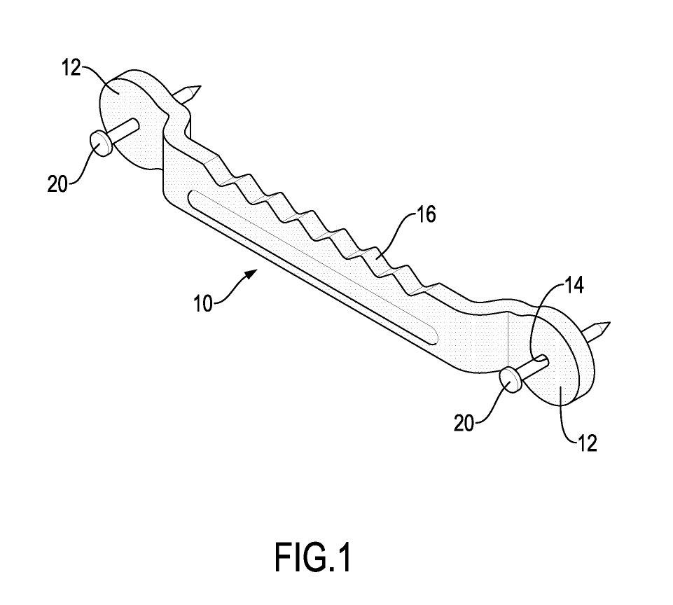

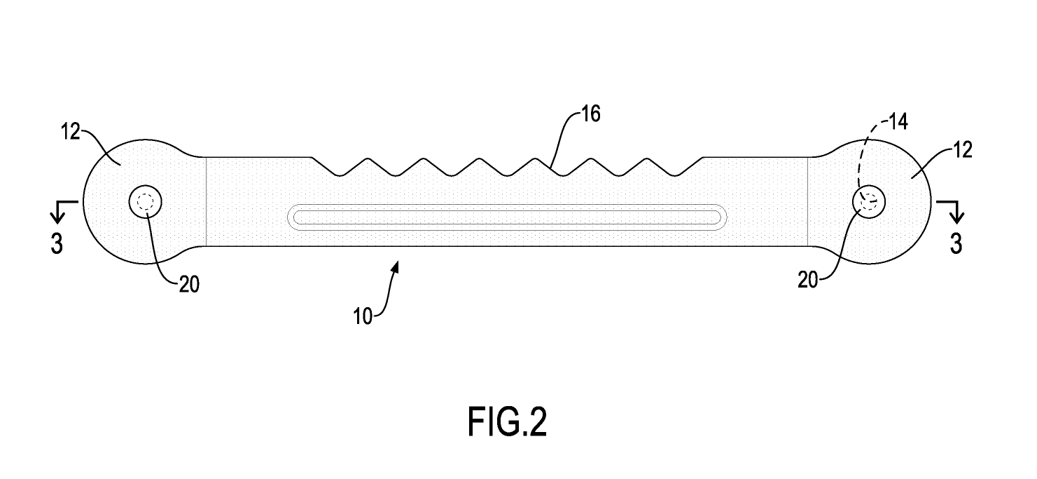

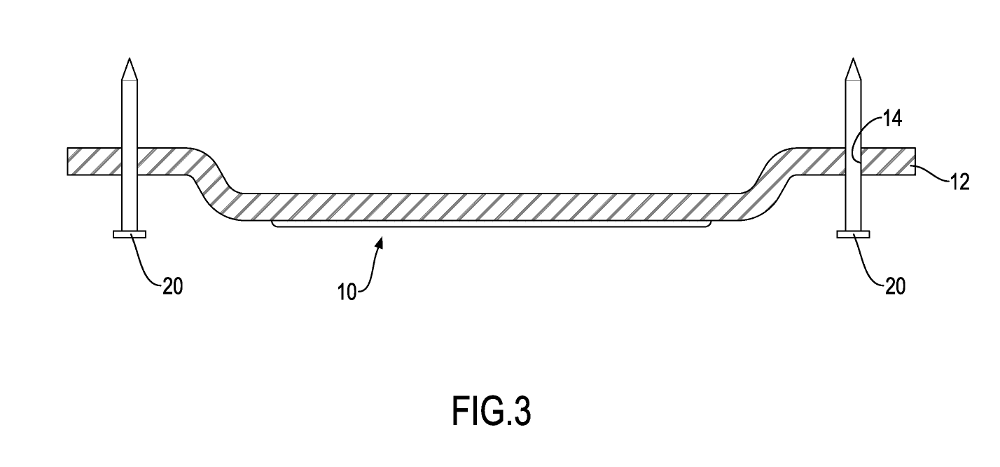

With reference to FIGS. 1 to 3, a hanger in accordance with the present invention comprises a body 10. The body is made of nylon, is U-shaped in cross section, and has two ends 12 and two through holes 14. The through holes 14 are defined respectively through the ends 12 of the body 10. Preferably, multiple teeth 16 are formed on a top edge of the body 10.

With the nylon body 10, two fasteners 20 inserted respectively into the through holes 14 can be firmly held in the through holes 14. Accordingly, the fasteners 20 can be kept from escaping from the through holes 14, and the hanger can be securely attached onto a flat object conveniently. In addition, the through holes 14 can provide a guiding effect to the fasteners 20 to prevent the fasteners 20 from being inclined during the process of attaching the hanger onto a flat object.

Furthermore, the nylon body 10 of the hanger in accordance with the present invention is not oxidized or rusted, so the useful life of the hanger can be effectively prolonged. In addition, the nylon body 10 of the hanger in accordance with the present invention has sufficient thickness and structural strength and is not easily deformed.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hanger comprising:
a body made of nylon, being U-shaped in cross section, and having two ends; and
two through holes defined respectively through the two ends of the body.

2. The hanger as claimed in claim 1, wherein the body further has multiple teeth formed on a top edge of the body.
